(19) United States
(12) Patent Application Publication
(10) Pub. No.: US 2012/0086280 A1
(43) Pub. Date: Apr. 12, 2012

(54) Power Supply System for Electrical Appliance

(76) Inventor: Yang Pan, Shanghai (CN)

(21) Appl. No.: 13/316,446

(22) Filed: Dec. 9, 2011

Related U.S. Application Data
(63) Continuation-in-part of application No. 12/577,152, filed on Oct. 10, 2009.

(51) Int. Cl. H02J 4/00

(52) U.S. Cl. 307/75

(57) ABSTRACT

A power supply system for an electrical appliance is disclosed. The system comprises a DC power path and an AC power path. Power limiters are used to limit output power to the appliance. A controller is used to maximize power consumption from DC path that receives the power from an alternative energy generation system such as a solar system.

### CROSS-REFERENCE TO RELATED APPLICATIONS

This application is a continuation in part of the application Ser. No. 12/577,152.

### BACKGROUND

1. Field of Invention

This invention relates to an electrical appliance, specifically to a power supply system including an AC source from a power grid and a DC source from an alternative energy generation system for powering an electrical appliance.

2. Description of Prior Art

In recent years, concerns have been raised that high demand for electricity taxing the capacity of existing electricity generating plants. Furthermore, concerns regarding the availability and environmental safety of fossil and nuclear fuel are being raised. As a result of the above factors, the price of electricity has been on a path of steady increasing.

Furthermore, the electrical utility industry has for some time labored under the problem of supplying cost effective power to comply system peak-demand period requirements. The concept of peak-demand power supplementation is not new. A number of systems have been tested and implemented over years based upon batteries, hydroelectric, and combustion turbine. Each of the systems, by nature or by implementation, has had problems. Some are expensive and others are not acceptable environmentally.

Solar systems have been used with gained popularity to resolve at least partially the peak-demand issue of the power grid. A solar system may convert generated DC electricity from solar panels into AC electricity and be used to power electrical appliance. The generated DC power may be purchased by a power grid company after it is converted into AC power by utilizing an inverter. Over the years inverters have progressed from electromechanical to semiconductor devices. The use of the inverters not only causes the loss of electrical power but also the increase of overall cost of the solar system.

It is desirable to have a system and method for utilizing the solar energy to supplement the peak demand of the power grid while eliminating the use of the inverters to reduce the cost of employing of solar systems.

### SUMMARY OF THE INVENTION

It is therefore an object of the present invention to provide a cost effective method for utilizing solar energy for electrical appliances by eliminating the use of high cost inverters.

It is another object of the present invention to provide an improved power supply system for an electrical appliance that consumes DC power from an alternative energy source directly whenever it is available while it uses AC power from the power grid as a backup or supplementary power source.

The power supply system based upon the present inventive concept comprises a first means of power supply based upon AC power from the power grid and a second means of power supply based upon DC power generated from an alternative energy source such as the solar system. A switch is used to switch in between the DC and the AC sources controlled by a controller. The controller measures the generated DC power regularly. The DC power generated by the alternative energy generation source is consumed as the first priority while the AC power from the power grid is used as a backup or supplementary source.

Performances of the power supply system may be improved by including one or more power limiters in DC and/or AC power paths. The power limiters may be constructed based upon integrated circuits with a thermal feedback loop.

### BRIEF DESCRIPTION OF THE DRAWINGS

For a more complete understanding of the present invention and its various embodiments, and the advantages thereof, reference is now made to the following description taken in conjunction with the accompanying drawings.

FIG. 1 is a schematic diagram of a power supply system for an electrical appliance.

FIG. 2 is a functional block diagram of an exemplary electrical appliance with a dual power source supply system.

FIG. 3 is a schematic diagram illustrating an exemplary implementation of a dual power source plug.

FIG. 4 is a schematic diagram illustrating a conversion of the plug for the dual power sources to for the single power source. The conversion is controlled by a mechanical switch.

FIG. 5 is a schematic diagram of the power source illustrating that the AC power from the power grid and the DC power from an alternative energy source.

FIG. 6A is a flow diagram depicting steps of a process illustrating operation of the dual power source supply system based upon one embodiment. According to the embodiment, the DC source is switched off when the measured DC power is below the threshold value.

FIG. 6B is a flow diagram depicting steps of a process illustrating operation of the dual power source supply system based upon another embodiment. According to the embodiment, the generated DC power is always consumed and the AC power is a supplementary source to the DC one.

FIG. 7 is a flow diagram depicting steps of a process illustrating operation of the dual power source supply system at an operational phase.

FIG. 8 is a functional block diagram of an exemplary electrical appliance with a dual power source supply system. A power limiter is coupled to output of voltage regulator to limit DC power from the power supply system.

FIGS. 9A and B are schematic diagrams of exemplary power limiters.

FIG. 10 is a functional block diagram of an exemplary electrical appliance with a dual power source supply system. A power limiter is placed in the DC power path to limit DC power from the power supply system.

FIG. 11 is a functional block diagram of an exemplary electrical appliance with a dual power source supply system. A power limiter is placed in the DC power path and another power limiter in the AC path to limit output power from the power supply system.

### DETAILED DESCRIPTION

The present invention will now be described in detail with references to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps have not been described in detail in order not to unnecessarily obscure the present invention.

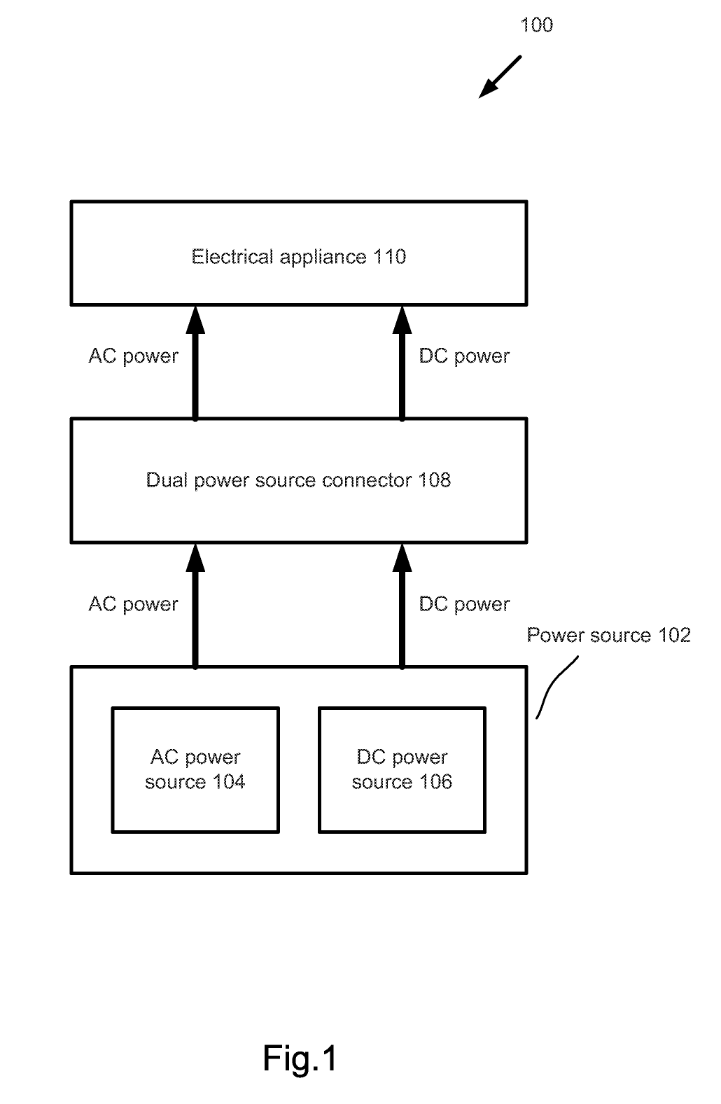

FIG. 1 is a schematic diagram of a power supply system for an electrical appliance. The system 100 comprises a power source 102 including an AC power source 104 and a DC power source 106. A dual power source connector 108 directs power from the power source 102 to an electrical appliance 110. In an exemplary case, the appliance 110 is a home electronic appliance such as a home audio system. The arrows in FIG. 1 indicate the direction of the power flow.

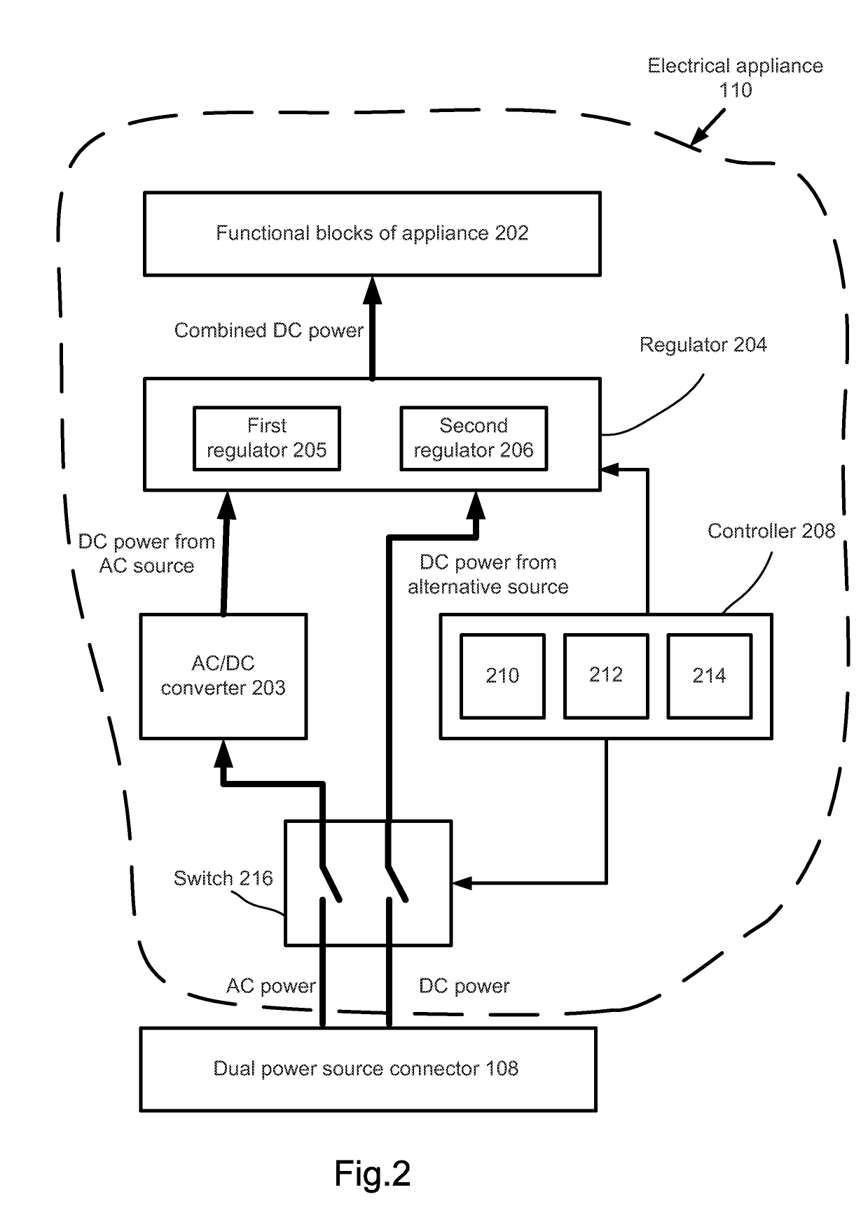

Functional blocks of the appliance 110 are further illustrated in FIG. 2. Block 202 represents all functional blocks of the appliance except for the power supply system. The power supply system comprises an AC path including an AC/DC converter 203 and a voltage regulator 204. The regulator 204 comprises a first voltage regulator 205 for regulating the output voltage from the AC/DC converter 203 for the operation of 202. The system further comprises a DC path from the alternative energy generation system connecting to the voltage regulator 204. The regulator 204 comprises a second voltage regulator 206. The output DC power from an alternative energy source may require further regulation to be consumed by the functional blocks 202. The alternative energy source is a solar system in the preferred embodiment of the present invention.

According to one aspect of the present invention, one of the two power paths is selected by a controller 208 through a switch 216. The controller 208 further comprises a measurement unit 210, a processor 212 and a battery 214. The measurement unit 210 is used to measure the generated DC power from the solar system. The controller receives the measurement results and decides if the DC or the AC power source is connected for powering the appliance. The switch 216 connects to the dual power source connector 108.

According to another aspect of the present invention, both of the power paths are connected to the functional blocks of the appliance 202 through the voltage regulator 204. The controller 208 is connected to the voltage regulator 204 to provide a means of controlling its operation. The available DC power from the alternative energy source is measured by 210 on a regular base. The required additional power is drawn from the AC source controlled by the controller 208. The voltage regulator 204 combines the regulated DC power from the alternative energy source and the regulated DC power converted from the AC/DC converter 203 before they are delivered to 202. The AC power is used as the supplementary power for the DC power whenever the DC power alone is insufficient to power the operations of the functional blocks of the appliance. The required power for the appliance may be pre-stored in a memory of the controller 208 or is determined on a real time base. The method is known in the prior art for determining required power consumption for an appliance.

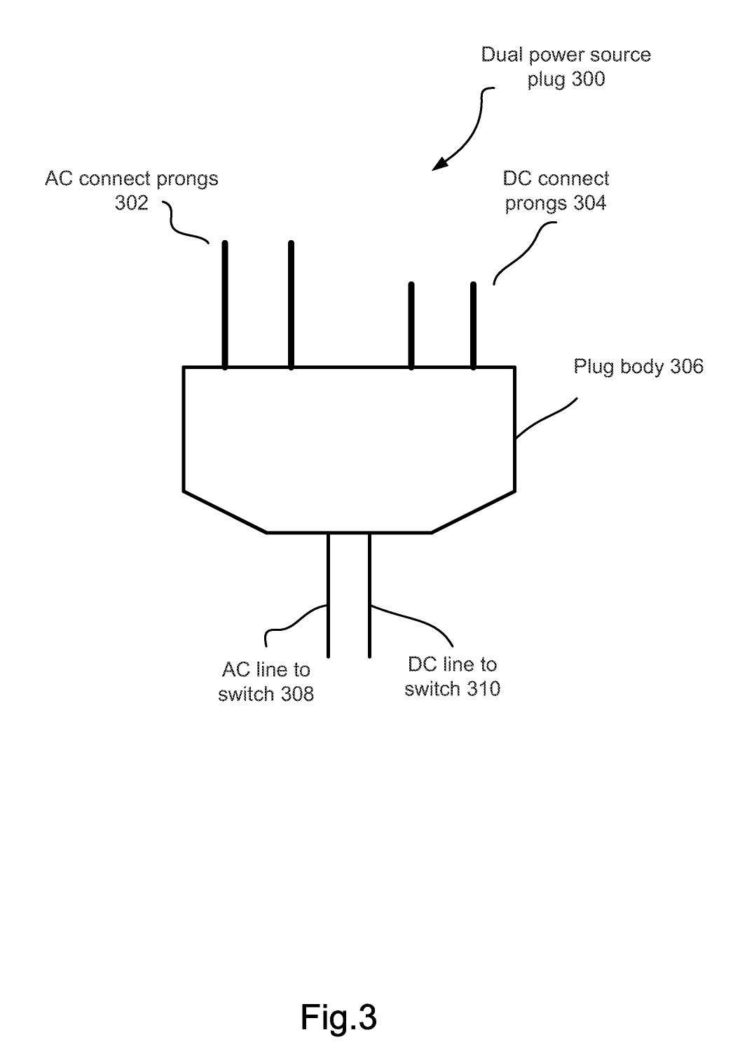

FIG. 3 is a schematic diagram illustrating an exemplary implementation of a dual power source connector as a plug. The plug 300 comprises a pair of long connect prongs 302 for connecting to the AC power source 104 and a pair of short connect prongs 304 for connecting to the DC power source 106. 302 and 304 are electrically insulated to satisfy all safety requirements. The connect prongs are connected to the power sources through multiple slots of a socket. 306 is the body for the plug 300. The plug 300 further comprises a group of power lines 308 to connect to the AC power source 104 and another group of power lines 310 to connect to the DC power source 106. It should be noted that there are numerous variations of the implementations of the plug within the scope of the present inventive concept. For example, 302 may be more than two connect prongs as illustrated in FIG. 3. There are also different ways to arrange 302 and 304. It is also not necessary that AC and DC prongs have different lengths. They may be differentiated by other means such as by different shapes and/or orientations.

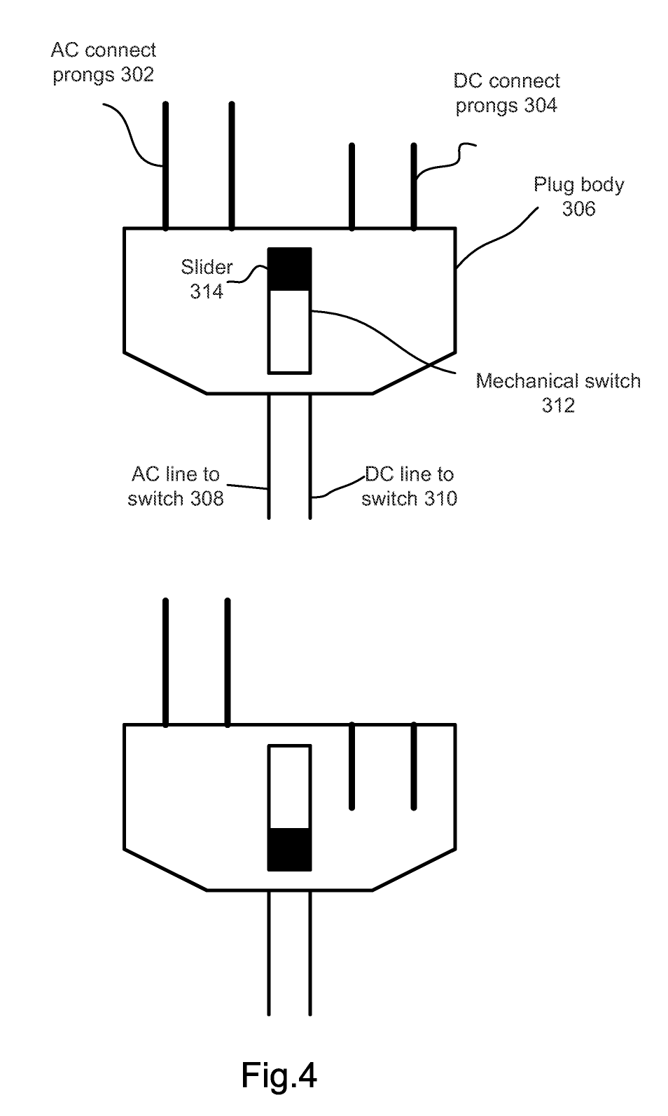

FIG. 4 is a schematic diagram illustrating a conversion from a dual power source plug to a single power source plug controlled by a mechanical switch 312 with a movable slider 314. When the slider 314 is pushed down by a user, the prongs 304 for the DC power source are then retrograde into the body of the plug. The similar implementation can be found in a conventional adapter for travelers. The present implementation is with a novel application for the device to select between the AC and the DC power sources.

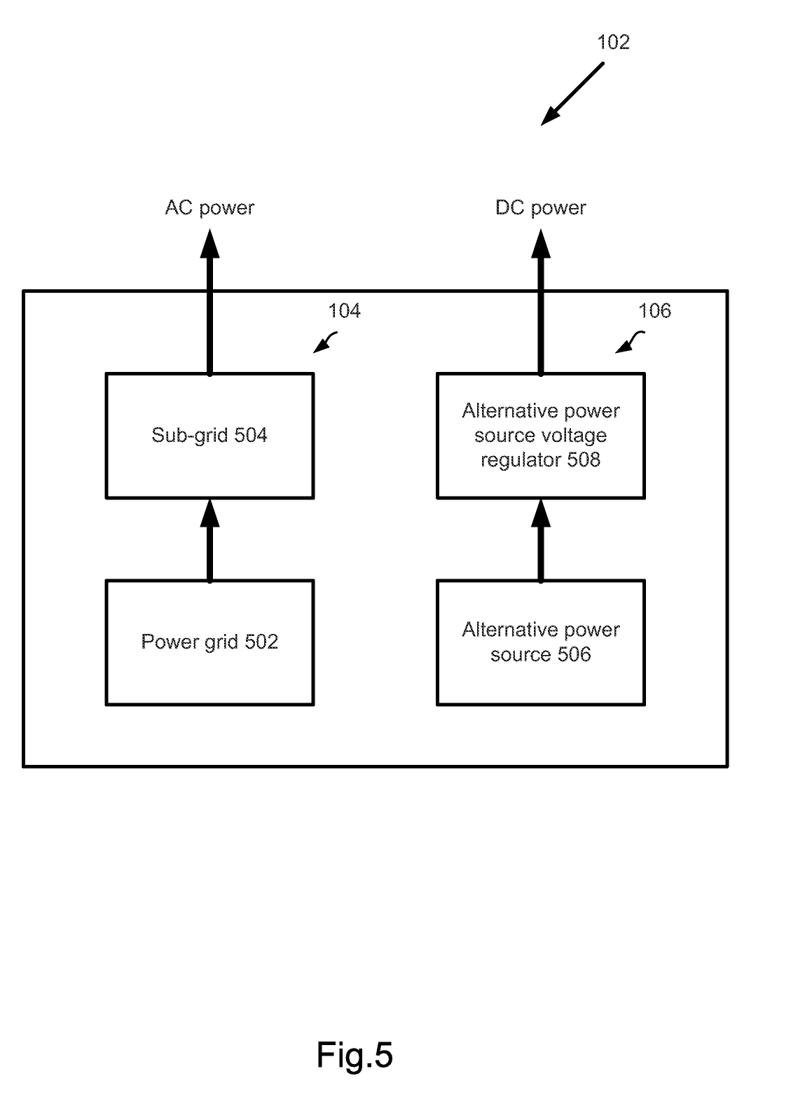

FIG. 5 is a schematic diagram illustrating that the AC power is delivered from the power grid and the DC power is delivered from an alternative energy source. The power source 102 comprises the AC power source 104 including a power grid 502 and a sub-grid 504 as known in prior art. The power source 102 further comprises the DC power source 106 including an alternative power source 506 and an alternative power source voltage regulator 508. In the preferred embodiment, 506 is a solar system. The solar system may comprise multiple solar panels. In one implementation, the solar system may be installed on the top of a roof for a house. The solar system converts the sun radiations into DC electricity based upon the well know photovoltaic effects. The maximum DC power is typically generated at noon which corresponds to the peak-demand of the electrical utility. By eliminating the inverters, the DC power is directly consumed by the electrical appliance at lower cost. The present invention indeed provides a low cost way to utilize the generated electricity from solar systems. It should be noted that the system based upon the present invention is best suited for the applications where the power grid is available. The appliance consumes DC power generated by solar system whenever it is available to save overall utility cost.

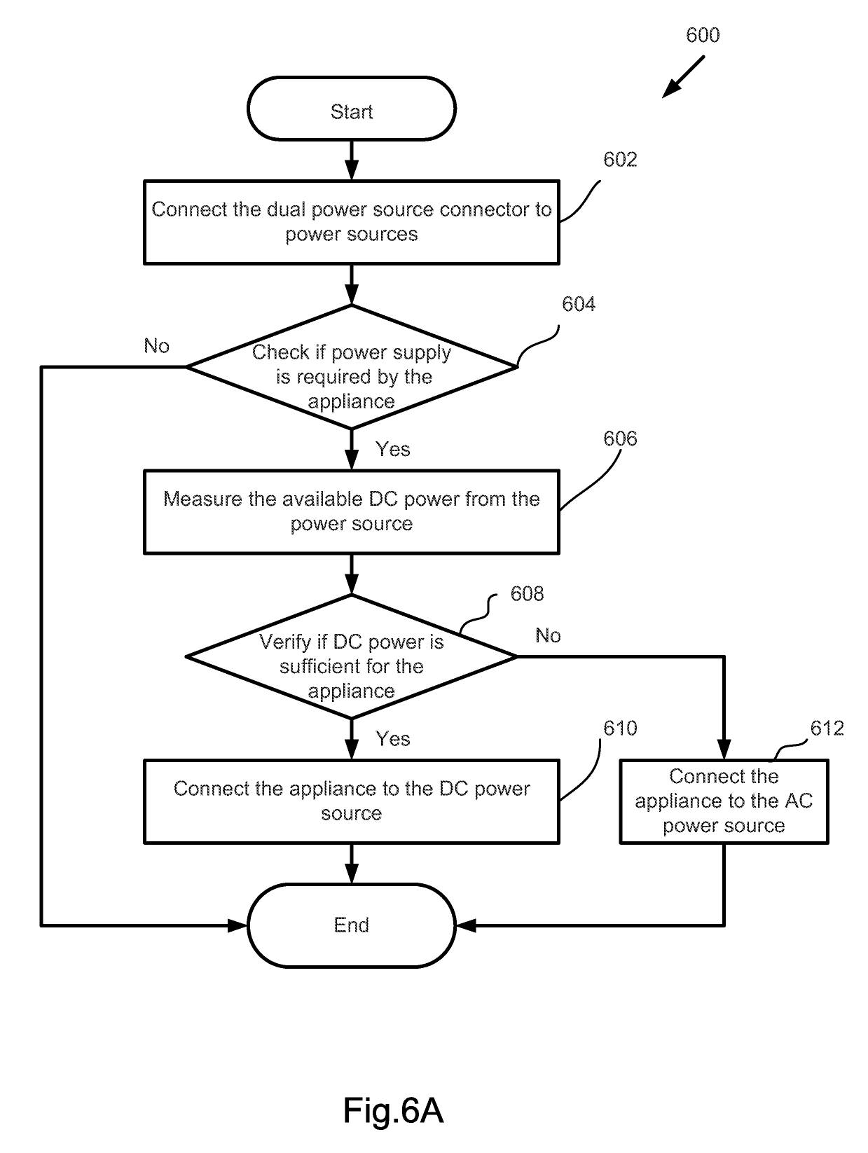

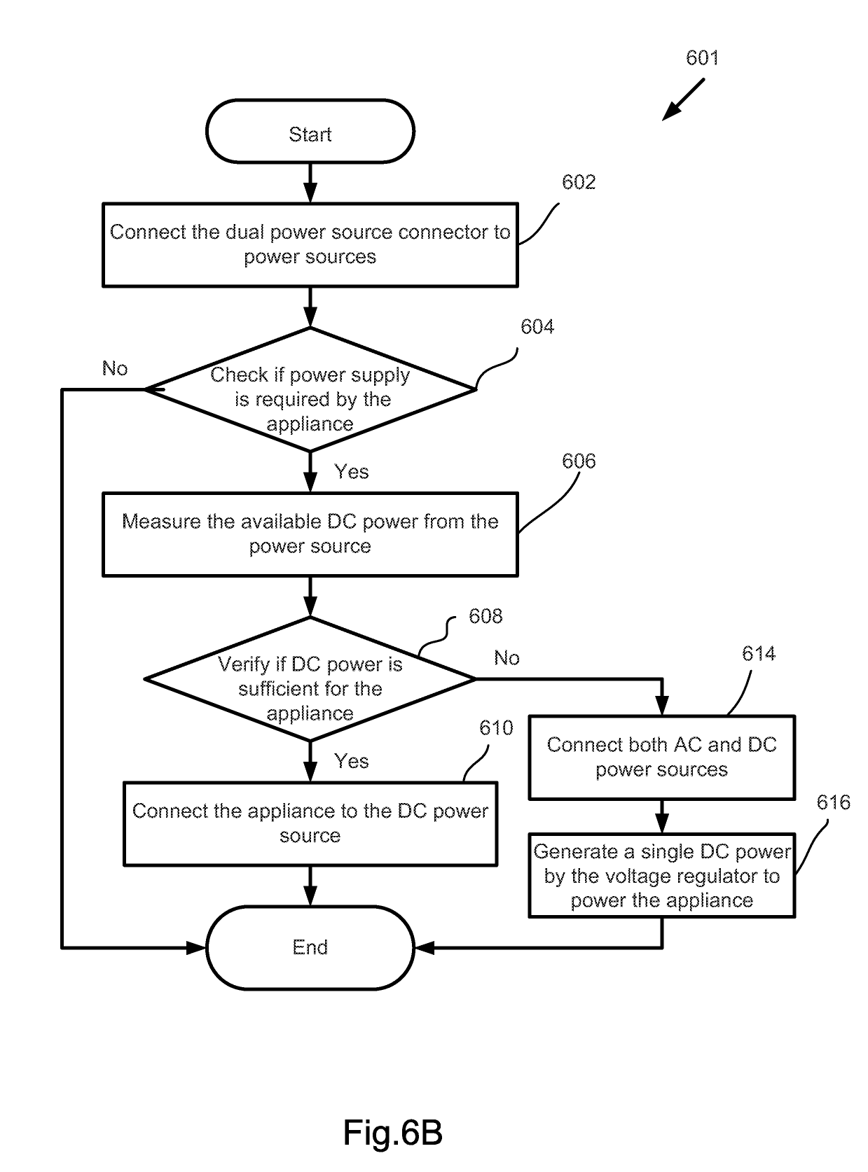

FIG. 6A is a flow diagram depicting steps of a process illustrating operation of the dual power source supply system. Process 600 starts with step 602 that the dual power source connector 108 is connected to the power source 102 by, in an exemplary case, plugging the plug 300 into a plurality of slots of a socket on a wall. In step 604, the controller checks if the power supply is required by the appliance as a result of an user switching on the device. If the result in the step 604 is positive, the DC power generated from the alternative power source 506 is measured by the measurement unit 210. The switch 216 connects the controller 208 to the DC power source 104 during the step. In step 608, the controller 208 verifies if the generated DC power is sufficient for powering the appliance. If the DC power is sufficient, the DC power source is connected in step 610 to the appliance for powering the operation. If the DC power is insufficient, the appliance is then connected to the conventional AC power source 104 in step 612 according to one embodiment of the present invention.

Another embodiment of the present invention is depicted in FIG. 6B by a process 601. The appliance is connected to the DC power source 106 if the measured power is verified by the controller 208 as sufficient for powering the appliance. According to the embodiment, even if the DC power is insufficient for powering the appliance, the generated DC power is still consumed by the appliance. Both DC and AC power sources are connected in step 614. A single regulated DC power is generated by the voltage regulator 204 controlled by 208 in step 616. The available DC power from the alternative energy generation system is measured on a regular base. The required additional power is drawn from the AC source controlled by the controller 208. The power consumption for the appliance is therefore a sum of the generated DC power from the alternative power generation system and the AC power from the power grid. The operation is controlled by the controller.

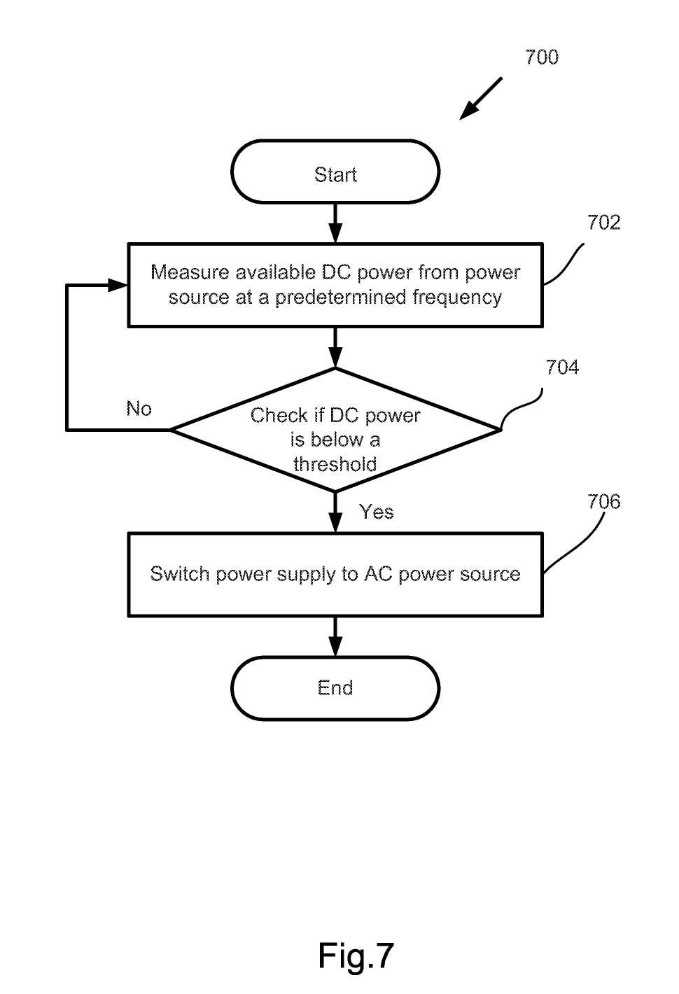

According to the embodiment described by the process 600, the DC power generated by the alternative energy generation system may vary. For example, the DC power generated by the solar panels may change if the received sun radiation is reduced due to the weather conditions. It is therefore necessary to monitor the available DC power on a regular base to prevent appliance malfunction. FIG. 7 is a flow diagram depicting steps of a process illustrating operation of the dual power source supply system during an operational phase. Process 700 starts with step 702 that available DC power is measured in a predetermined frequency. If the generated DC power is verified as below a threshold value in step 704, the switch 216 switches the appliance to the AC power source 104.

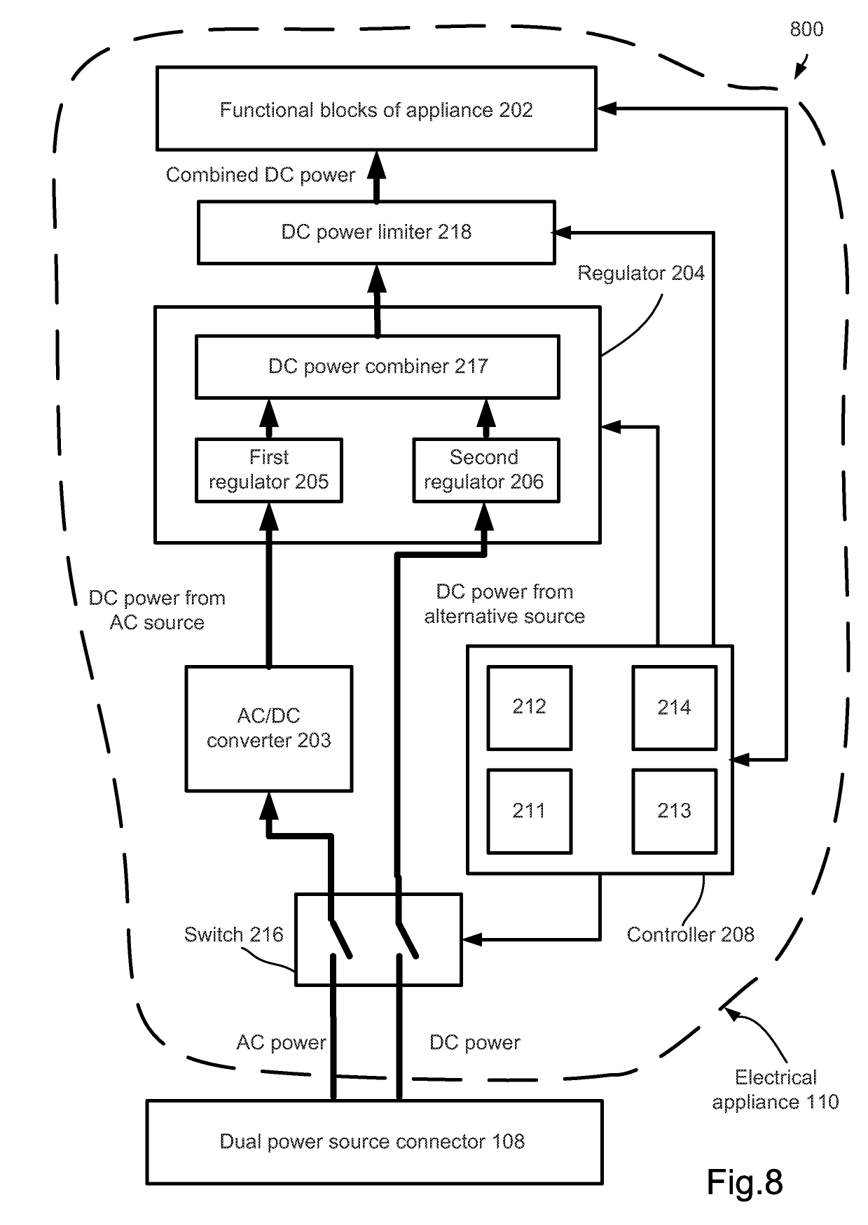

FIG. 8 shows a functional block diagram of an exemplary electrical appliance according to an alternative embodiment (800). An exemplary appliance 110 according to the embodiment comprises a DC power combiner 217 that combines regulated DC powers from the first regulator 205 and the second regulator 206. The output of regulator 204 is coupled to a DC power limiter 218. Power limiter 218 sets a maximum power that the power supply system delivers to the functional blocks 202. Power limiter 218 may be controlled by controller 208. In the embodiment, controller 208 may further comprise a supply detector 211 (e.g. replace measurement unit 210 in the previous embodiment as depicted in FIG. 2) and a demand detector 213 according to one aspect of the embodiment. Adding blocks 211 and/or 213 to controller 208 is optional in an exemplary manner. This should not limit the scope of the present invention according to the present embodiment. Supply detector 211 measures voltage-current characteristic of alternative energy generation system 506 and determines optimal operating point for maximum power out. According to one implementation of the present invention, system 506 is a solar system. It is well known that solar system generates maximum output power when it is operated at an optimal operating point.

Demand detector 213 is used to measure power supply requirement from functional blocks 202. Controller 208 receives measured available DC power by 211 and measured required DC power by 213. The maximum power of DC power limiter is subsequently determined by the controller 208. DC power limiter 218 is a programmable unit controlled by controller 208.

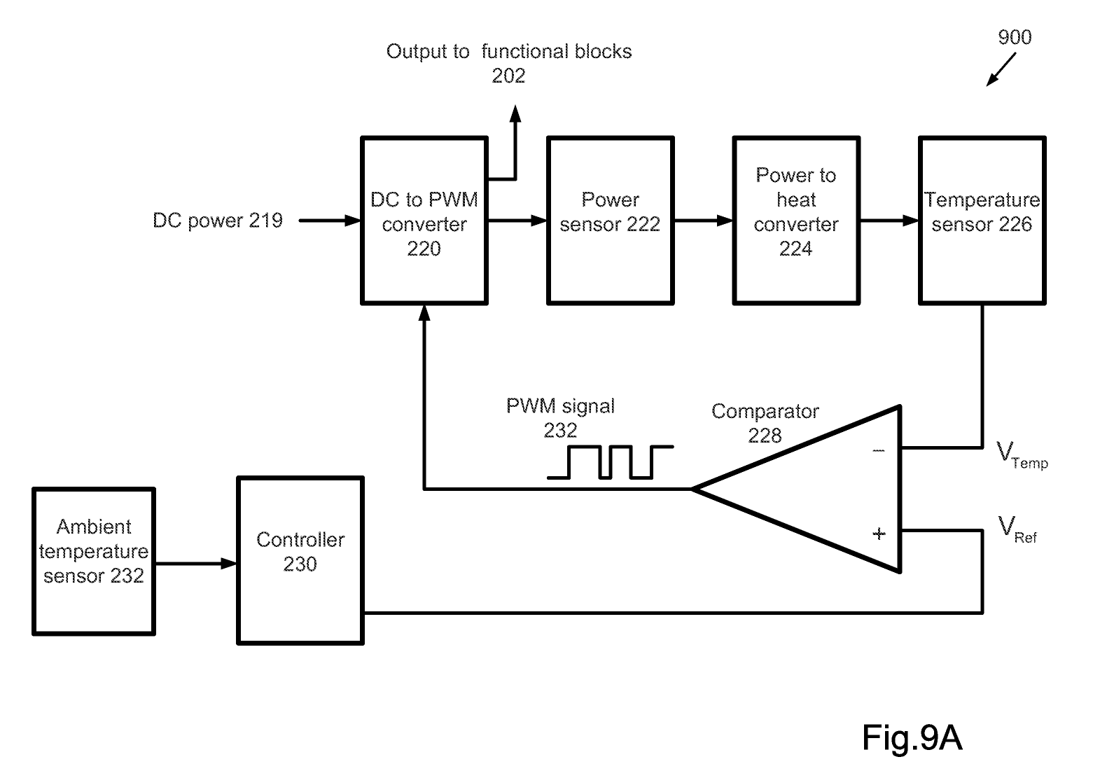

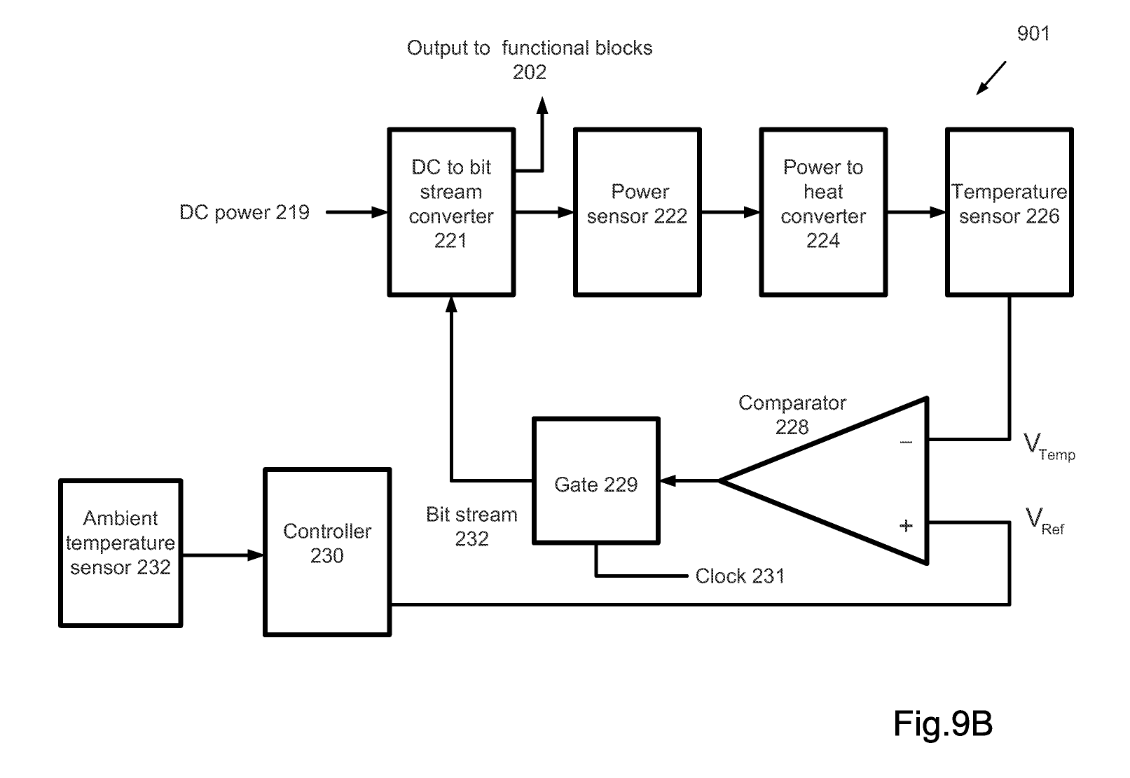

FIG. 9A is an exemplary DC power limiter based upon an integrated circuit for measurements of thermal signals comprising a thermal feedback loop.

Such an implementation is known from an article by Pan (the present inventor) and Huijsing in Electronic Letters 24 (1988), 542-543. This circuit is theoretically appropriate for measuring physical quantities such as speed of flow, pressure, IR-radiation, or effective value of electrical voltage or current (RMS), the influence of the quantity grated integrated circuit (chip) to its environment being determined in these cases. In these measurements, a signal conversion takes place twice: from physical (speed of flow, pressure, IR-radiation or RMS value) to the thermal domain, and from the thermal to the electrical domain.

This known semiconductor circuit theoretically consists of a heating element, integrated in the circuit, and a temperature sensor. The power dissipated in the heating element is measured with the help of an integrated amplifier unit, an amplifier with a positive feedback loop being used, because of which the temperature oscillates around a constant value with small amplitude. In the known circuit the temperature will oscillate in a natural way because of the existence of a finite transfer time of the heating element and the temperature sensor with a high amplifier-factor.

FIG. 9A shows an exemplary power limiter implemented in DC power domain. System 900 comprises incoming DC power 219. DC power 219 may be, in an exemplary manner, an output from voltage regulator 204 that combines DC power from alternative energy generation source 506 and DC power from output of AC/DC converter. DC power 219 is coupled to a first input of DC to PWM converter 220 that connects a second input to a PWM signal 232. DC power sensor 222 is coupled to block 220 to draw a predetermined proportional portion of DC power. Block 220 delivers output power to functional blocks 202 in PWM form. According to one aspect, the output power may be rectified to a DC power before it is delivered to block 202. The DC power received by DC power sensor 222 is coupled to power to heat converter (heating element) 224. Temperature sensor 226 measures temperature of the microstructure (chip) that includes the heating element. Comparator 228 takes one input from the output of temperature sensor 226 and takes another input from a reference generated from controller 230. Controller 230 may be the same controller as 208. Controller 230 may be a different controller. Output of comparator 228 in PWM form (232) is coupled to a second input of block 220 to modulate the incoming DC power 219. The temperature of the chip will oscillate around a small value set by the reference. Block 220 converts the DC power into DC power in PWM form. The output power of block 220 is therefore determined by duty cycle of the PWM signal while the amplitude is kept constant.

The maximum output power of block 220 is determined by the reference that sets a level of temperature that the chip or the microstructure will oscillate around. To sustain a higher temperature, the power sensor 222 will need to draw more power from DC to PWM converter 220. The reference is determined by controller 230. Controller 230 may determine the reference based upon the available DC power from the alternative power source 506 and further upon the power demand from functional blocks 202.

It should be noted that the temperature level of the microstructure or the chip also depends on ambient temperature. At a lower ambient temperature, it requires more power to heat the heating element to maintain the temperature to oscillate around the predetermined level. At a higher ambient temperature, less power is required. In one aspect of the present invention, an ambient temperature sensor 232 is used to measure the ambient temperature. The measurement results are sent to controller 230. Temperature sensor 232 may be a sensor independent of the integrated circuit or the chip. Temperature sensor 232 may also be a part of the integrated circuit or the chip that will require an appropriate thermal isolation between temperature sensor 232 and temperature sensor 226. Such thermal isolation techniques are known in the art.

There may be different implementations of integration level of system 900. At a minimum level, 224 and 226 are integrated in a single chip or in a single microstructure. At a higher level, 228 may also be integrated (e.g., 224, 226 and 228 in a single chip). At even higher levels, 220 and 222 may also be integrated (e.g., 224, 226, 228, 220 and 222 in a single chip). At still higher level, 230 and 232 may also be integrated (e.g., 224, 226, 228, 220, 222, 230 and 232 in a single chip). All such variations shall fall within the scope of inventive concepts of the present invention.

FIG. 9B illustrates an alternative embodiment of the power limiter (901). In the embodiment, the incoming DC power 219 is coupled to a first input of DC to bit stream converter 221 that converts the DC power into bit stream form by connecting a second input of 219 to a bit stream signal 232 to modulate the incoming DC power 219. A predetermined proportional portion of DC power is received by power sensor 222 and is converted to heat by power to heat converter or heating element (224). Comparator 228 takes output of temperature sensor 226 as a first input and a reference generated by controller 230 as a second input. The output of comparator 228 is coupled to a first input of gate 229 which has a second input connected to a clock signal 231. The output of gate 229 in bit stream form is coupled to the second input of block 221. The reference generated by controller 230 that sets a level of temperature that the chip or the microstructure will oscillate around and therefore sets the output power to functional blocks 202.

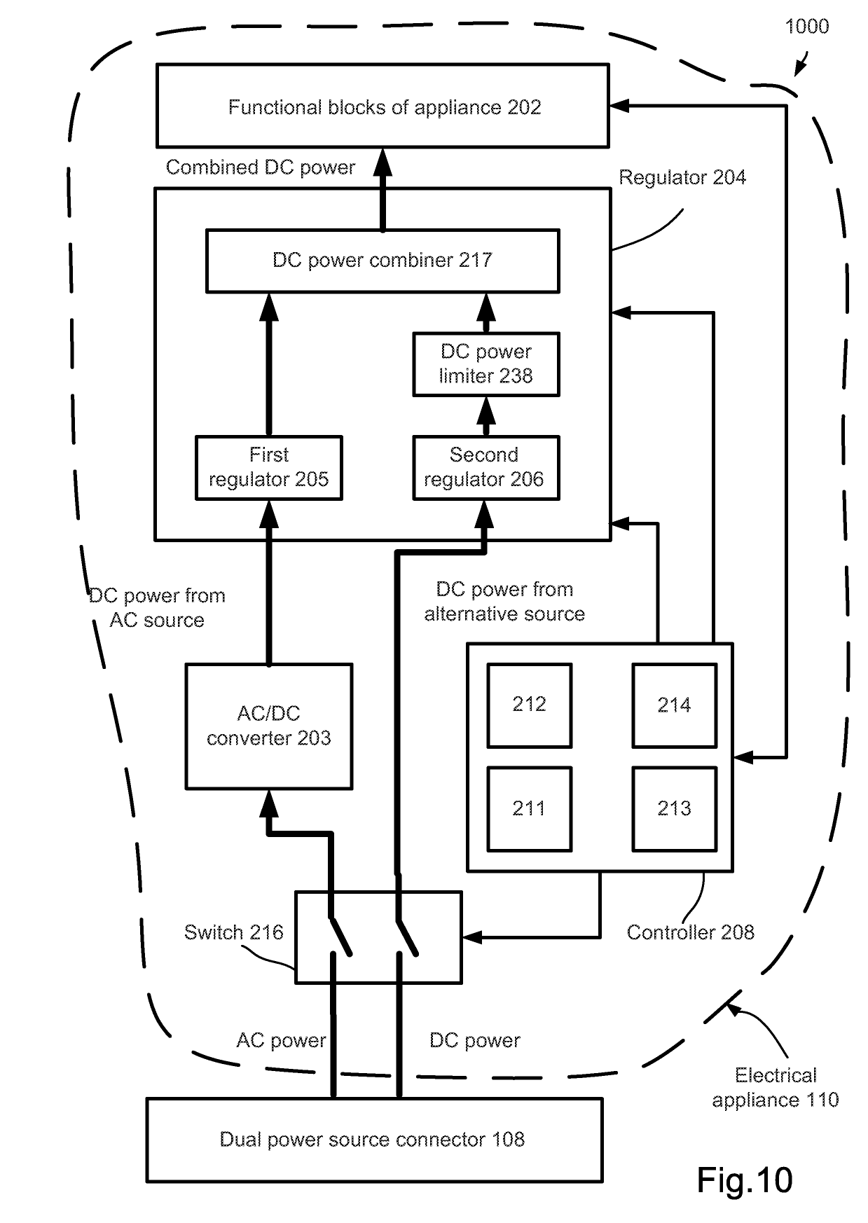

FIG. 10 shows an exemplary implementation of power supply system for an electrical appliance (1000). Power limiter 238 is coupled to output of the second regulator 206 in the DC path. DC powers from DC power limiter 238 and from the first regulator 205 in the AC path are combined in DC power combiner 217. There may be an additional rectifier (not shown in FIG. 10) to convert electrical power in PWM form into DC power before the power is delivered to combiner 217. Output of combiner 217 is feed into functional block 202.

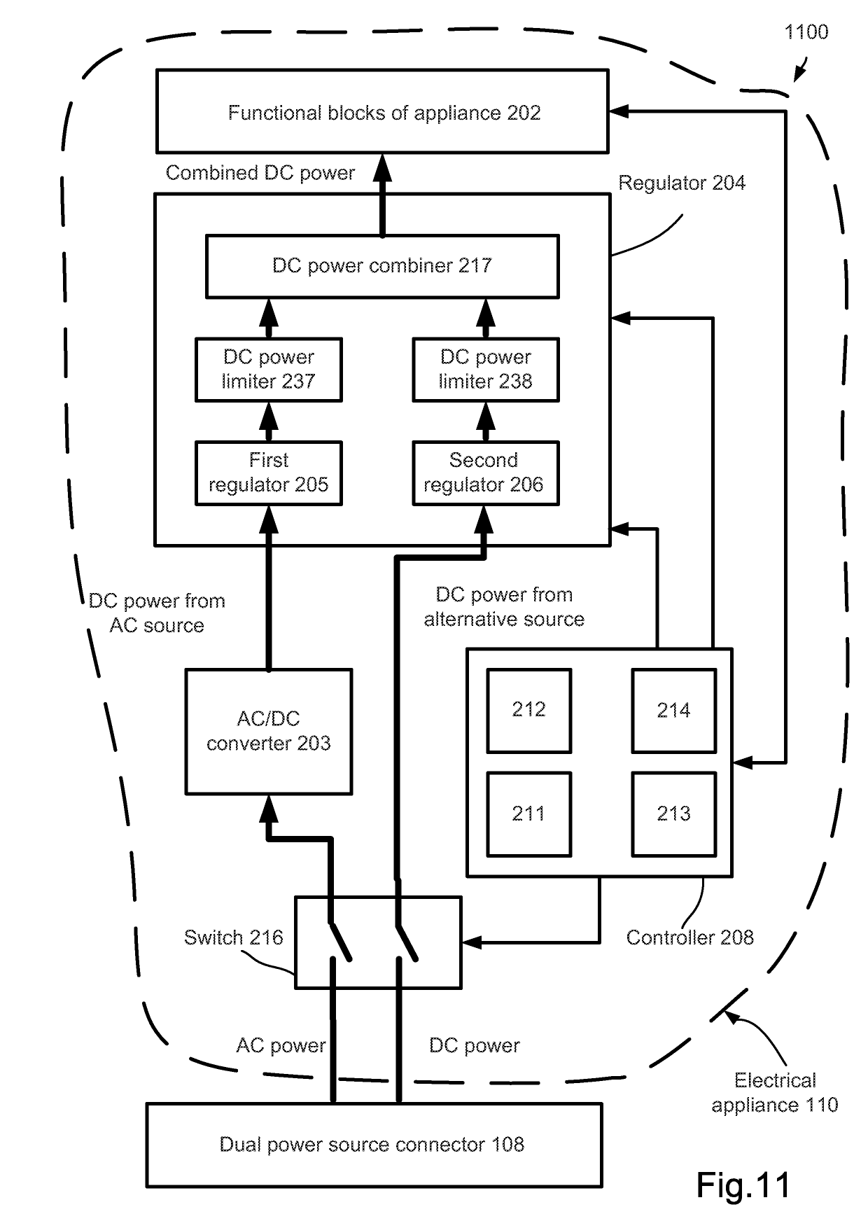

FIG. 11 shows another exemplary implementation of power supply system for an electrical appliance (1100). In the embodiment, a first power limiter 237 is coupled to output of the first regulator 205 in the AC path. A second power limiter 238 is coupled to output of the second regulator 206 in the DC path. DC powers from 237 and 238 are combined in DC power combiner 217. There may be an additional rectifier (not shown in FIG. 11) to convert electrical power in PWM form into DC power before the power is delivered to combiner 217. Output of combiner 217 is feed into functional block 202.

It should be noted that the inventive concept of placing a power limiter in the power path can be extended to implementations wherein the power supply system for electrical appliances that comprises a DC path only or an AC path only. The present inventive concept is general to include such variations in simplifications.

While the invention has been disclosed with respect to a limited number of embodiments, numerous modifications and variations will be appreciated by those skilled in the art. Additionally, although the invention has been described particularly with respect to electrical appliances, it should be understood that the inventive concepts disclosed herein are also generally applicable to other system, apparatus, consumer electronic products, computing system, media delivery systems, lighting system and production tools that consume electrical power. The inventive concepts are also applicable to other appliances and systems that consume directly AC power. An additional DC/AC converter may be added using known methods in the art. Furthermore, the present inventive concepts are applicable to any implementation of power limiters. It is intended that all such variations and modifications fall within the scope of the following claims:

1. A power supply system for an electrical appliance comprising:
(a) an AC power path for receiving AC power from a power grid, wherein said AC path further comprising an AC/DC converter and a first switch;
(b) a DC power path for receiving DC power from an alternative energy generation system, wherein said DC path further comprising a second switch;
(c) a regulator taking DC path as a first input and taking output of the AC/DC converter as a second input and having a single regulated DC power as an output;
(d) a power limiter for limiting output power of said regulator; and
(e) a controller for controlling operations of said power supply system, wherein said controller further provides a means of maximizing power consumption from said DC power path.

2. The system as recited in claim 1, wherein said controller further comprising a supply detector for determining maximum power generated from said alternative energy generation system.

3. The system as recited in claim 1, wherein said controller further comprising a demand detector for determining required power from the electrical appliance.

4. The system as recited in claim 3, wherein said controller determines maximum power of the power limiter in accordance with said required power determined by said demand detector.

5. The system as recited in claim 1, wherein said power limiter may be constructed based upon a thermal feedback loop, wherein said thermal feedback loop further comprising a DC power converter, a power sensor, a heating element, a temperature sensor, a comparator and a controller, wherein said comparator taking output of the temperature sensor as a first input and taking a reference generated by the controller as a second input and having a PWM signal as output which is coupled to an input of the DC power converter.

6. The system as recited in claim 5, wherein said thermal feedback loop further comprising a gate including a first input coupled to output of the comparator, a second input coupled to a clock signal and output coupled to the DC power converter, wherein said gate converts PWM signal into bit stream signal.

7. The system as recited in claim 5, wherein said power limiter further comprising an ambient temperature sensor for measuring ambient temperature, wherein the measured ambient temperature is received by the controller and is used as one of factors to determine the reference.

8. The system as recited in claim 1, wherein said alternative energy generation system further comprising a solar system, wherein said solar system further comprising one or a plurality solar panels.

9. A power supply system for an electrical appliance comprising:
(a) an AC power path for receiving AC power from a power grid, wherein said AC path further comprising an AC/DC converter and a first switch;
(b) a DC power path for receiving DC power from an alternative energy generation system, wherein said DC path further comprising a second switch;
(c) a regulator taking DC path as a first input and taking output of the AC/DC converter as a second input and having a single regulated DC power as an output;
(d) a power limiter in said DC path for limiting DC power output; and
(e) a controller for controlling operations of said power supply system, wherein said controller further provides a means of maximizing power consumption from said DC power path.

10. The system as recited in claim 9, wherein said controller further comprising a supply detector for determining maximum power generated from said alternative energy generation system.

11. The system as recited in claim 9, wherein said controller further comprising a demand detector for determining required power from the electrical appliance.

12. The system as recited in claim 11, wherein said controller determines maximum power of the power limiter in accordance with said required power determined by said demand detector.

13. The system as recited in claim 9, wherein said power limiter may be constructed based upon a thermal feedback loop, wherein said thermal feedback loop further comprising a DC power converter, a power sensor, a heating element, a temperature sensor, a comparator and a controller, wherein said comparator taking output of the temperature sensor as a first input and taking a reference generated by the controller as a second input and having a PWM signal as output which is coupled to an input of the DC power converter.

14. The system as recited in claim 13, wherein said thermal feedback loop further comprising a gate including a first input coupled to output of the comparator, a second input coupled to a clock signal and output coupled to the DC power converter, wherein said gate converts PWM signal into bit stream signal.

15. The system as recited in claim 13, wherein said power limiter further comprising an ambient temperature sensor for measuring ambient temperature, wherein the measured ambient temperature is received by the controller and is used as one of factors to determine the reference.

16. The system as recited in claim 9, wherein said alternative energy generation source further comprising a solar system, wherein said solar system further comprising one or a plurality solar panels.

17. A power supply system for an electrical appliance comprising:
(a) an AC power path for receiving AC power from a power grid, wherein said AC path further comprising an AC/DC converter and a first switch;
(b) a DC power path for receiving DC power from an alternative energy generation system, wherein said DC path further comprising a second switch;
(c) a regulator taking DC path as a first input and taking output of the AC/DC converter as a second input and having a single regulated DC power as an output;
(d) a first power limiter in said AC path for limiting AC power output;
(e) a second power limiter in said DC path for limiting DC power output; and
(f) a controller for controlling operations of said power supply system, wherein said controller further provides a means of maximizing power consumption from said DC power path.

18. The system as recited in claim 19, wherein said alternative energy generation source further comprising one or a plurality of solar panels, wherein said controller further comprising a means of determining optimal operating point for generating maximum power of the solar panels and determining maximum power of said power limiter based upon the determined optimal operating point.

19. The system as recited in claim 18, wherein said power limiter may be constructed based upon a thermal feedback loop, wherein said thermal feedback loop further comprising a DC power converter, a power sensor, a heating element, a temperature sensor, a comparator and a controller, wherein said comparator taking output of the temperature sensor as a first input and taking a reference generated by the controller as a second input and having a PWM signal as output which is coupled to an input of the DC power converter.

20. The system as recited in claim 19, wherein said thermal feedback loop further comprising a gate including a first input coupled to output of the comparator, a second input coupled to a clock signal and output coupled to the DC power converter, wherein said gate converts PWM signal into bit stream signal.
